(19) United States
(12) Patent Application Publication
(10) Pub. No.: US 2007/0047264 A1
(43) Pub. Date: Mar. 1, 2007

(54) Mold frame with reduced yellowing

(76) Inventors: Byung-Yun Joo, Goyang-si (KR); Jin-Soo Kim, Seoul (KR); Ju-Hwa Ha, Seoul (KR); Jung-Wook Paek, Seoul (KR); Sang-Hoon Lee, Yongin-si (KR); Min-Young Song, Daejeon (KR)

Correspondence Address: MACPHERSON KWOK CHEN & HEID LLP, 2033 GATEWAY PLACE, SUITE 400, SAN JOSE, CA, 95110, US

(21) Appl. No.: 11/510,019

(22) Filed: Aug. 24, 2006

(30) Foreign Application Priority Data
Aug. 25, 2005 (KR) 2005-78112

(51) Int. Cl. F21V 7/04

(52) U.S. Cl. 362/633

(57) ABSTRACT

A mold frame that does not yellow with exposure to ultraviolet radiation is presented. The mold frame includes a first portion, a second portion and a silicone layer. The first portion supports the optical member. The second portion extends from the first member and reflects a light generated from the lamp. The first silicone layer is coated on the second portion. With the silicone layer formed on the mold frame, yellowing is prevented and display quality is improved.

### CROSS-REFERENCE TO RELATED APPLICATIONS

This application relies for priority on Korean Patent Application No. 2005-78112 filed on Aug. 25, 2005, the content of which is herein incorporated by reference in its entirety.

### BACKGROUND OF THE INVENTION

1. Field of the Invention

The present invention relates generally to a mold frame, and particularly to a mold frame capable of preventing yellowing.

2. Description of the Related Art

In general, a liquid crystal display (LCD) device displays an image by using optical and electrical properties of liquid crystals, such as their anisotropic refractive index and their anisotropic dielectric constant. A liquid crystal display device includes a liquid crystal display panel that displays an image using light transmittance through a layer of liquid crystal molecules and a backlight assembly that provides the liquid crystal display panel with light.

The backlight assembly includes a lamp that emits light and a mold frame securing an end portion of the lamp. Additionally, the mold frame reflects the light generated by the lamp toward the liquid crystal display panel.

When the liquid crystal display device is operated, the mold frame yellows over time due to the ultraviolet light and heat applied thereto. The yellowing is undesirable because it lowers the display quality of the liquid crystal display device.

### SUMMARY OF THE INVENTION

The present invention provides a mold frame capable of preventing yellowing caused by ultraviolet light and heat applied thereto. The present invention also provides a method of manufacturing the above-mentioned mold frame. The present invention also provides a backlight assembly having the above-mentioned mold frame. The present invention also provides a display device having the above-mentioned mold frame.

In one aspect of the present invention, a mold frame covering an end portion of a lamp and supporting an optical member disposed over the lamp includes a first portion, a second portion and a silicone layer. The first portion supports the optical member. The second portion is extended from the first portion and reflects a light generated from the lamp. The silicone layer is coated on the second portion.

In another aspect of the present invention, a method of manufacturing a mold frame is presented. The method includes three forming a body that reflects light generated from a lamp is formed. The body includes a first portion that supports an optical member and a second portion that extends from the first portion. An adhesive layer is formed on a surface of the body to improve the adhesive property. A silicone layer is formed on the adhesive layer.

In yet another aspect of the present invention, a backlight assembly includes a lamp, an optical member, a receiving container and a mold frame. The lamp generates light. The optical member improves characteristics of the light generated from the lamp. The optical member is disposed on the lamp. The receiving container receives the lamp and the optical member. The mold frame has a silicone layer coated thereon, holds the lamp, and supports the optical member.

In yet another aspect of the present invention, a display device includes a display panel and a backlight assembly. The backlight assembly provides the display panel with light. The display panel displays an image by using the light. The backlight assembly includes a lamp, an optical member and a mold frame. The lamp generates light. The optical member enhances characteristics of the light generated from the lamp and is disposed upon the lamp. A silicone layer including a reflecting material is coated on the mold frame, and the mold frame covers an end portion of the lamp and supports the optical member.

According to the above, the silicone layer is formed on the mold frame, so that yellowing of the mold frame may be prevented, which improve display qualities.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view illustrating a mold frame according to an embodiment of the present invention;

FIG. 2 is a cross-sectional view taken along the line I-I′ in FIG. 1;

FIG. 3 is a flow chart showing a method of manufacturing the mold frame according to an embodiment of the present invention;

FIGS. 4A to 4C are cross-sectional views illustrating a method of manufacturing the mold frame in FIG. 3;

FIG. 5 is an exploded perspective view illustrating a backlight assembly according to an embodiment of the present invention;

FIG. 6 is a cross-sectional view taken along the line II-II′ in FIG. 5;

FIG. 7 is a cross-sectional view taken along the line III-III′ in FIG. 5;

FIG. 8 is an exploded perspective view illustrating a backlight assembly according to another embodiment of the present invention;

FIG. 9 is an exploded perspective view illustrating a backlight assembly according to yet another embodiment of the present invention;

FIG. 10 is an enlarged view illustrating the portion “A” in FIG. 9;

FIG. 11 is a cross-sectional view taken along the line IV-IV′ in FIG. 9;

FIG. 12 is a cross-sectional view taken along the line V-V′ in FIG. 9;

FIG. 13 is an exploded perspective view illustrating a. display device according to yet another embodiment of the present invention;

FIG. 14 is a graph showing a relationship between ultraviolet light and yellow index; and

FIG. 15 is a graph showing a relationship between the wavelength of incident light and a reflecting ratio.

### DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected or coupled to the other element or layer or intervening elements or layers may be present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

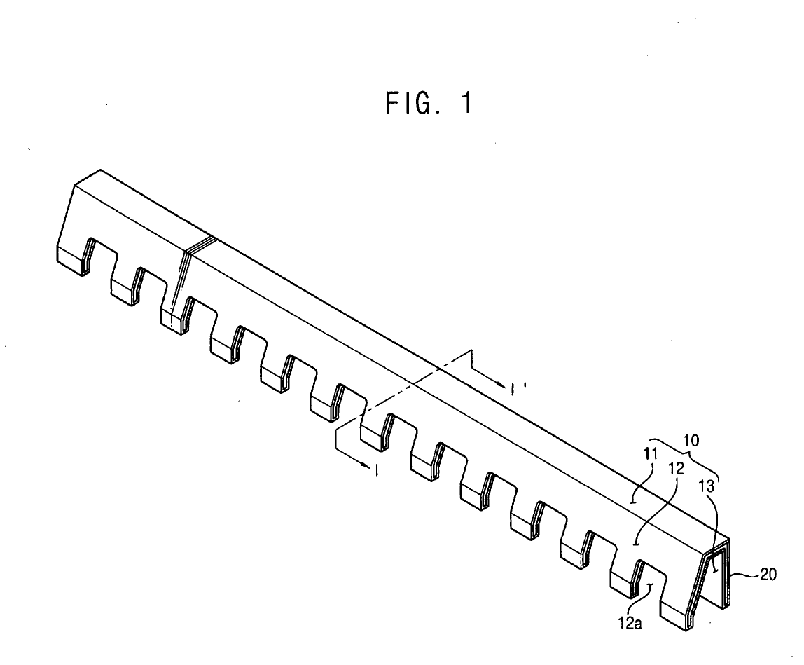

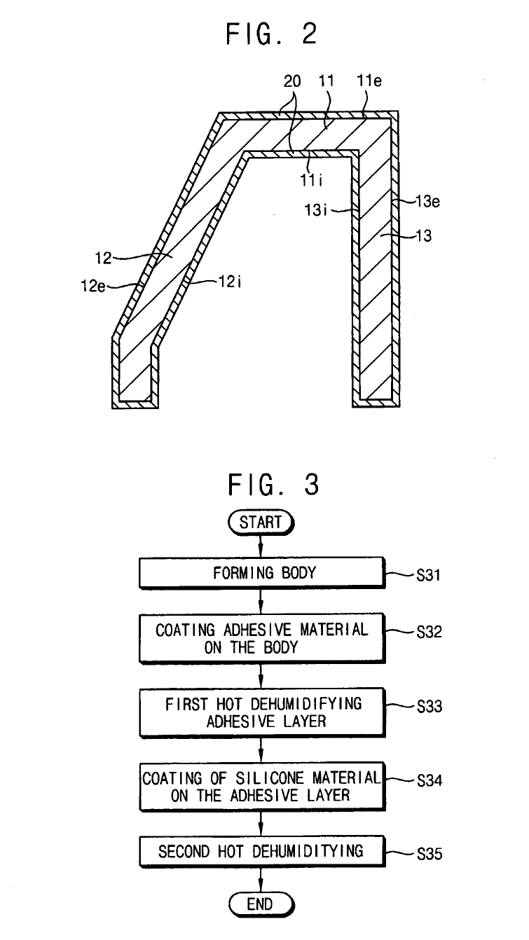

FIG. 1 is a perspective view illustrating a mold frame according to an embodiment of the present invention. FIG. 2 is a cross-sectional view taken along the line I-I′ in FIG. 1.

Referring to FIGS. 1 and 2, a mold frame includes a body 10 and a silicone layer 20 coated on a surface of the body 10. The body 10 includes polycarbonate. The body is formed through, for example, injection molding. The body 10 includes a first portion 11, a second portion 12, and a third portion 13. The first portion 11 supports an optical member (not shown) that is disposed on the mold frame.

The second portion 12 extends from the first portion 11. The second portion 12 reflects the light from the lamp. The mold frame covers an end portion of the lamp that it holds. More specifically, the second portion 12 includes an opening 12a that is shaped to accommodate a lamp, and the end portion of the lamp is inserted into the opening 12a of the second portion 12.

The third portion 13 extends from the first portion 11. The third portion 13 extends from an edge of the first portion 11 that is opposite the edge that contacts the second portion 12. The third portion 13 supports the first portion 11 so that the first portion 11 is spaced apart from a base surface (not shown) by a predetermined distance. The optical members that are disposed on the first portion 11 are spaced apart from the lamp disposed on the base surface.

The silicone layer 20 is coated on the external surfaces 11e, 12e and 13e and on the inner surfaces 11i, 12i and 13i of the first to third portions 11, 12 and 13, respectively, to prevent a yellowing of the first to third portions 11, 12 and 13. The first to third portions 11, 12, and 13 yellow as a result of exposure to ultraviolet light generated by the lamp.

The silicone layer 20 has a thickness of about 30 μm to about 40 μm. The silicone layer 20 may be made of, for example, a reflecting material mixed with silicone resin. The reflecting material is a white material such as titanium oxide. Where titanium oxide is used, the titanium content may be between about 6% and about 7% by weight.

The silicone layer 20 prevents yellowing of the body 10, which is caused by breaking of the molecular structure of the body 10. The body 10 has a double bond between carbon and oxygen, which breaks upon exposure to ultraviolet light generated by the lamp. As the molecular structure of the silicone layer 20 does not include a carbon-oxygen double bond, silicone layer 20 does not turn yellow due to exposure to ultraviolet light. Hence, coating with the silicon layer 20 prevents yellowing.

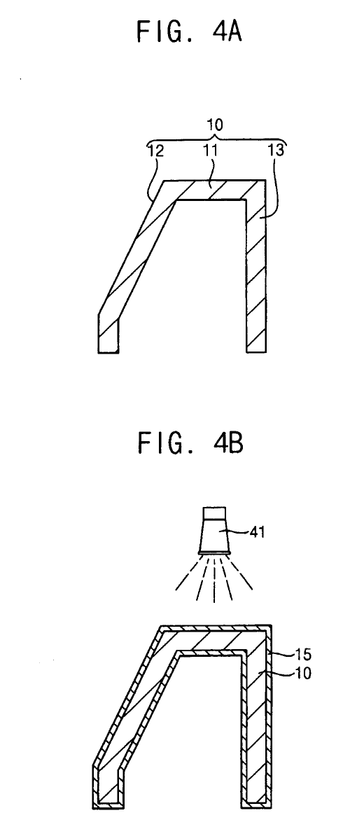

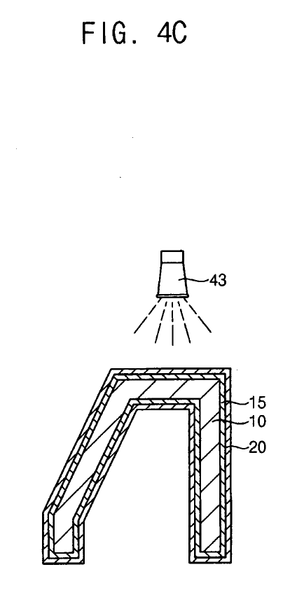

Hereinafter, a method of manufacturing a mold frame according to the present invention will be explained with reference to FIGS. 3 to 4C.

FIG. 3 is a flow chart showing a method of manufacturing the mold frame according to an embodiment of the present invention. FIGS. 4A to 4C are cross-sectional views illustrating a method of manufacturing the mold frame in FIG. 3.

Referring to FIGS. 3 to 4C, the body 10 of the mold frame is formed. In detail, a molding case having a cavity corresponding to the shape of the body 10 receives a molten resin so that the body 10 of the mold frame is injection molded (step S31). The molten resin may include a polycarbonate of aromatic group, an impact stiffener and a flame retardant. Polycarbonate includes engineering plastics having a certain mechanical property, a flame-resistant property, a freeze-resistant property, a certain electrical property, etc. In addition to a relatively high strength. FIG. 4A shows the body 10 made of polycarbonate.

To improve the adhesive property, a first spray nozzle 41 coats a primer as an adhesive material onto a surface of the body 10 (FIG. 4B and S32 of FIG. 3). The surface of the body 10 includes, as described in FIG. 2, an external surface 11e, 12e and 13e and inner surface 11i, 12i and 13i of the first to third portions 11, 12 and 13, respectively.

Then, a hot blaster heating machine (not shown) supplies a hot wind to the body 10 having the adhesive material coated thereon. This hot blasting is part of the first dehumidification of the adhesive layer to form the adhesive layer 15 (step S33).

Subsequently, a second spray nozzle 43 coats a silicone material on the adhesive layer 15 (FIG. 4C and S34 of FIG. 3). The adhesive layer 15 improves the adhesion between the body 10 and the silicone material.

Subsequently, a hot blaster heating machine (not shown) supplies a hot wind to the body 10 having the silicone material coated thereon. This hot blasting is part of the second dehumidification of the silicone material to form the silicone layer 20 (step S35).

The mold fame having the silicone layer coated thereon is thus manufactured.

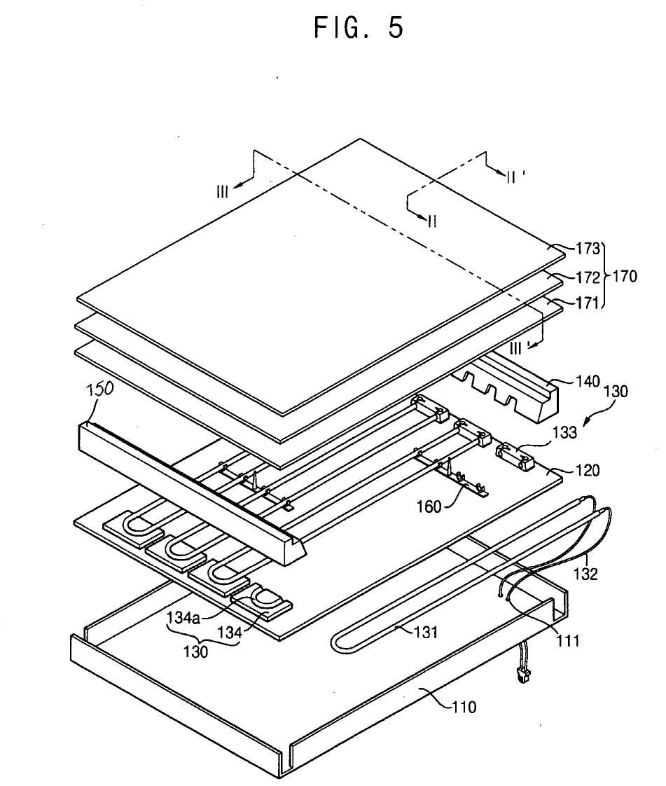

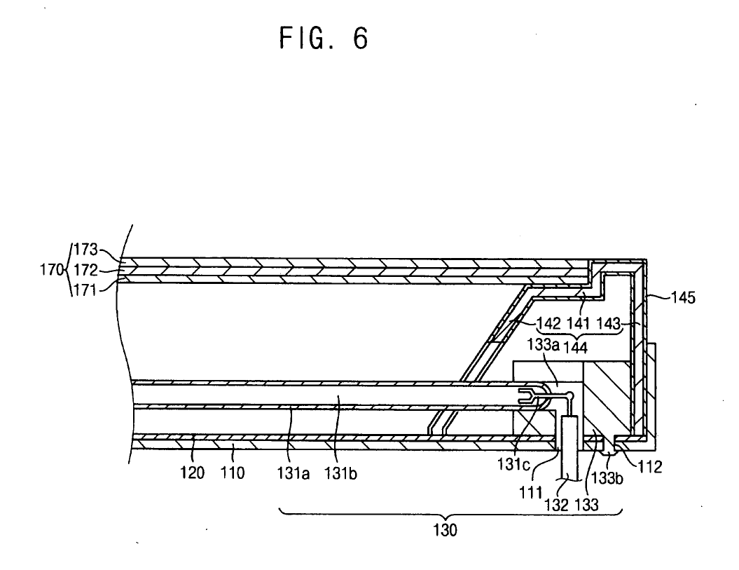

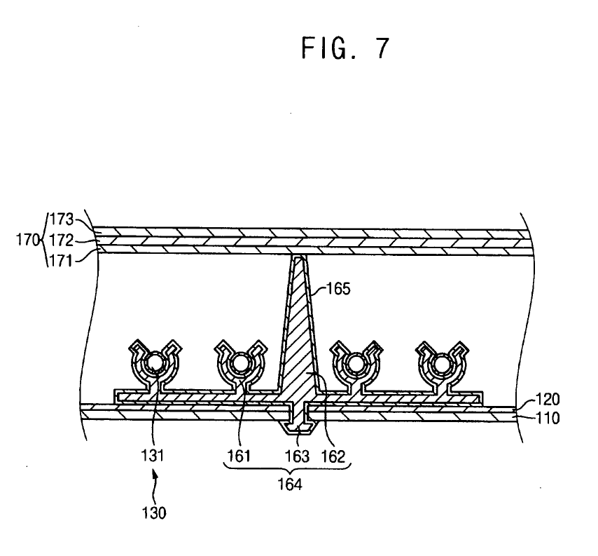

FIG. 5 is an exploded perspective view illustrating a backlight assembly according to an embodiment of the present invention. FIG. 6 is a cross-sectional view taken along the line II-II′ in FIG. 5. FIG. 7 is a cross-sectional view taken along the line III-III′ in FIG. 5.

Referring to FIGS. 5 to 7, the backlight assembly includes a receiving container 110, a reflecting plate 120, a lamp assembly 130, a first side mold 140, a second side mold 150, a lamp supporting member 160 and an optical member 170.

The receiving container 110 includes a bottom plate and a plurality of sidewalls that extend from the edge portions of the bottom plate. The bottom plate and the sidewalls define a receiving space. The reflecting plate 120, the lamp assembly 130, the first side mold 140, the second side mold 150, the lamp supporting member 160 and the optical member 170 are disposed in the receiving space of the receiving container 110.

A plurality of first holes 111 are formed in the bottom plate to guide a plurality of lamp wires of the lamp assembly 130 outside of the receiving container 110. Optionally, a plurality of second holes (not shown) may be formed in the bottom plate to secure a plurality of lamp holders of the lamp assembly 130.

The reflecting plate 120 is disposed on the bottom plate of the receiving container 110 and reflects the light generated by the lamp assembly 130. Although the reflecting plate 120 is formed separately from the receiving container 110 in FIGS. 5 to 7, the reflecting plate 120 may be formed on the bottom plate of the receiving container 110 by coating a reflecting material on the bottom plate.

The lamp assembly 130 includes a lamp 131, a lamp wire 132, a lamp holder 133 and a lamp securing member 134.

The lamp 131 is, for example, an inner electrode fluorescent lamp having an electrode formed therein. The lamp 131 includes a lamp body 131a, a discharge gas 131b and an electrode 131c. The lamp body 131a may have, for example, a U-shape, and be made of a transparent glass. A fluorescent layer is formed on an inner surface of the lamp body 131a. The discharge gas 131b is injected into the lamp body 131a. The fluorescent gas includes, for example, mercury (Hg), argon (Ar), neon (Ne), xenon (Xe) and krypton (Kr).

The electrode 131c is disposed at an end portion of the lamp body 131a. In detail, two electrodes 131c are disposed at first and second end portions of the lamp body 131a, respectively. The electrode 131c corresponds to the shape of the lamp body 131a. A driving voltage generated by a power supplier (not shown), such as an inverter, is applied to the electrode 131c.

When the driving voltage generated by the power supplier (not shown) is applied to the electrode 131c, the discharge gas 131b generates invisible light such as ultraviolet light. The ultraviolet light is converted into a visible light by a fluorescent layer (not shown) formed on the inner surface of the lamp body 131a.

The lamp wire 132 is electrically connected to the electrode 131c of the lamp 131. The lamp wire 132 transmits the driving voltage from the inverter to the electrode 131c.

The lamp holder 133 supports the end portions of the lamp 131. A guide hole 133a and a securing protrusion 133b are formed on the lamp holder 133. The guide hole 133a guides a lamp wire 132. The securing protrusion 133b secures the lamp holder 133 to the receiving container 110.

The lamp securing member 134 secures the portion of the lamp 131 that is near the U-bend. A securing slot 134a corresponding to a shape of the center portion of the lamp 131 is formed on the lamp securing member 134. For example, the lamp securing member 134 may be fastened to the reflecting plate 120. Alternatively, the lamp securing member 134 may be fastened to the receiving container 110.

The first side mold 140 covers the end portion of the lamp 131 by covering the lamp holder 133 and supports the optical member 170. The second side mold 150 covers the U-bend portion of the lamp 131 by covering the lamp securing member 134 and supports the optical member 170. The first and second side molds 140 and 150 are substantially the same as the mold frame that is described in FIGS. 1 to 4c except for the first portion.

That is, the first side mold 140 includes a first body 144 and a first silicone layer 145 coated on an outer surface of the first body 144. The first body 144 comprises a first portion 141, a second portion 142 and a third portion 143. The first portion 141 supports the optical member 170. The first portion 141 may have a stepped portion in order to prevent a floating of the optical member 170 disposed on the first portion 141. The second portion 142 reflects a light generated from the lamp 131 toward the optical member 170.

The first silicone layer 145 is coated on the first body 144 of the first side mold 140. With the first silicone layer 145, the yellowing of the first body 144 caused by ultraviolet radiation in the light is prevented.

The second side mold 150 has a structure and function that are substantially the same as those of the first side mold 140. Thus, any redundant explanation of the second side mold 150 will be omitted.

The lamp supporting member 160 supports the lamp 131 so that the lamp 131 is spaced apart from the bottom plate of the receiving container 110. The lamp supporting member 160 includes a second silicone layer 165 that is coated on the outer surface of the first body 144 and the second body 164. The second body 164 includes a lamp securing portion 161 securing the lamp 131, a supporting portion 162 supporting the optical member 170 and a body securing portion 163 securing the body 164 to the receiving container 110.

The first body 144 and the second body 164 may be made of substantially the same material such as polycarbonate (PC). The first silicone layer 145 and the second silicone layer 165 may have substantially the same composition. Therefore, the yellowing of the second body 164 caused by ultraviolet radiation in the light is prevented, just as the yellowing of the first body 144 is prevented.

A method of manufacturing the lamp supporting member 160 is substantially the same as the method of manufacturing the mold frame, as mentioned above in FIGS. 3 to 4C.

More particularly, a molding case having a cavity corresponding to the shape of the second body 164 receives a molten resin during the injection-molding of the second body 164. A first spray nozzle coats a primer as an adhesive material on a surface of the second body 164. Subsequently, a second spray nozzle coats a silicone material on the adhesive material. The silicone material is coated to have a thickness of about 30 μm to about 40 μm. The silicone material includes, for example, a reflecting material mixed with a silicone resin. The reflecting material is a white material such as titanium oxide. Where titanium oxide is used, the titanium content is between about 6% and about 7% by weight.

The optical member 170 includes a diffusing plate 171, a first prism sheet 172 and a second prism sheet 173. The diffusing sheet 171 diffuses the light generated by the lamp 131 to improve luminance uniformity.

The first and second prism sheets 172 and 173 are disposed on the diffusing plate 171. The first and second prism sheets 172 and 173 improve a front-view luminance of the light exiting from the diffusing plate 171. “Front,” as used herein, is the top with respect to FIG. 5. Additionally, a protecting sheet (not shown) is disposed on the first and second prism sheets 172 and 173, so that the protecting sheet protects the first and second prism sheets 172 and 173 from a scratch or heat.

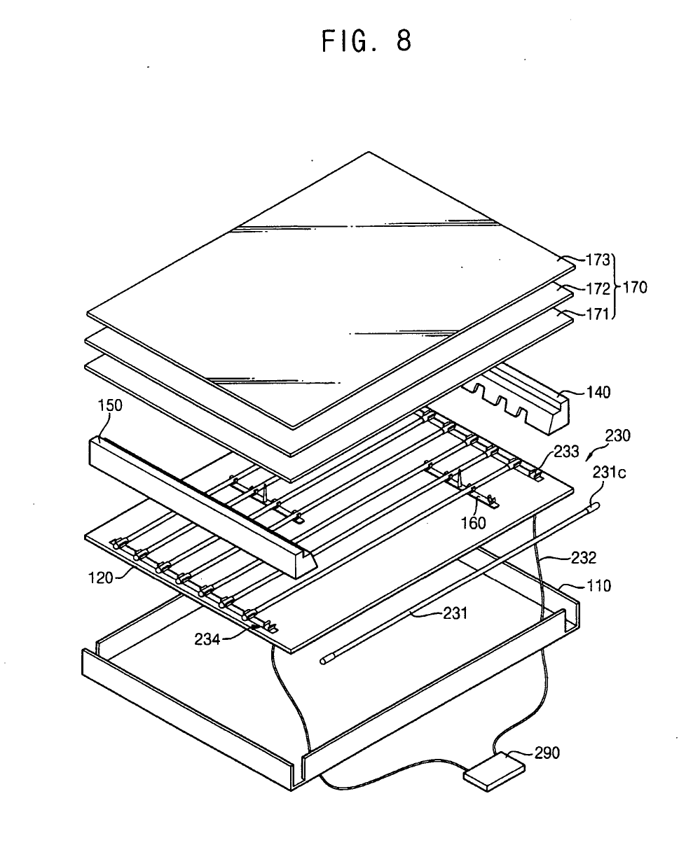

FIG. 8 is an exploded perspective view illustrating a backlight assembly according to another embodiment of the present invention.

Referring to FIG. 8, the backlight assembly includes a receiving container 110, a reflecting plate 120, and a lamp assembly 230 in addition to the first side mold 140, the second mold 150, the lamp supporting member 160 and the optical member 170.

The lamp assembly 230 includes a lamp 231, a lamp wire 232, a first lamp clip 233 and a second lamp clip 234.

The lamp 231 is, for example, an external electrode fluorescent lamp (EEFL) having an electrode formed therein. The lamp 231 includes a lamp body (not shown), a discharge gas (not shown) and an electrode 231c. The lamp body having a cylindrical shape may be made of a transparent glass. A fluorescent layer is formed on an inner surface of the lamp body. The discharge gas is injected into the lamp body. The discharge gas may include, for example, mercury (Hg), argon (Ar), neon (Ne), xenon (Xe) and krypton (Kr).

The electrodes 231c are disposed at two end portions of the lamp 231. A driving voltage generated from a power supplier 290 (not shown), such as an inverter, is applied to the electrodes 231c.

When the driving voltage is applied to the electrodes 231c, the discharge gas is injected into the lamp body and invisible light, such as ultraviolet light, is generated. The ultraviolet light is converted into visible light by a fluorescent layer that is coated on the inner surface of the lamp body.

The lamp wire 232 is electrically connected to the electrode 231c of the lamp. The lamp wire 232 transmits the driving voltage from the inverter 290 to the electrode 231c.

The first lamp clip 233 is disposed to couple to a first end of the lamp 231 and electrically connected to the lamp wire 232. The first lamp clip 233 secures the first end of the lamp 231 and applies a first driving voltage from the lamp wire 232 to the external electrode 231c of the lamp 231 secured by the first lamp clip 233.

The second lamp clip 234 is disposed to couple to a second end of the lamp 231 and electrically connected to the lamp wire 232. The second lamp clip 234 secures the second end of the lamp 231 and applies a second driving voltage generated from the lamp wire 232 to the external electrode 231c of the lamp 231 secured by the second lamp clip 234.

The first side mold 140 covers the first end of the lamp 231 and the lamp clip 233. The first side mold 140 supports the optical member 170. The second side mold 150 covers the second end of the lamp 231 and the lamp clip 234. The second side mold 150 supports the optical member 170.

The lamp supporting member 160 supports the lamp 231 so that the lamp 231 is spaced apart from the bottom plate of the receiving container 110.

The structures and functions of the first side mold 140, the second side mold 150 and the lamp supporting member 160 have been described in FIGS. 5 to 7, and thus any redundant explanation will be omitted.

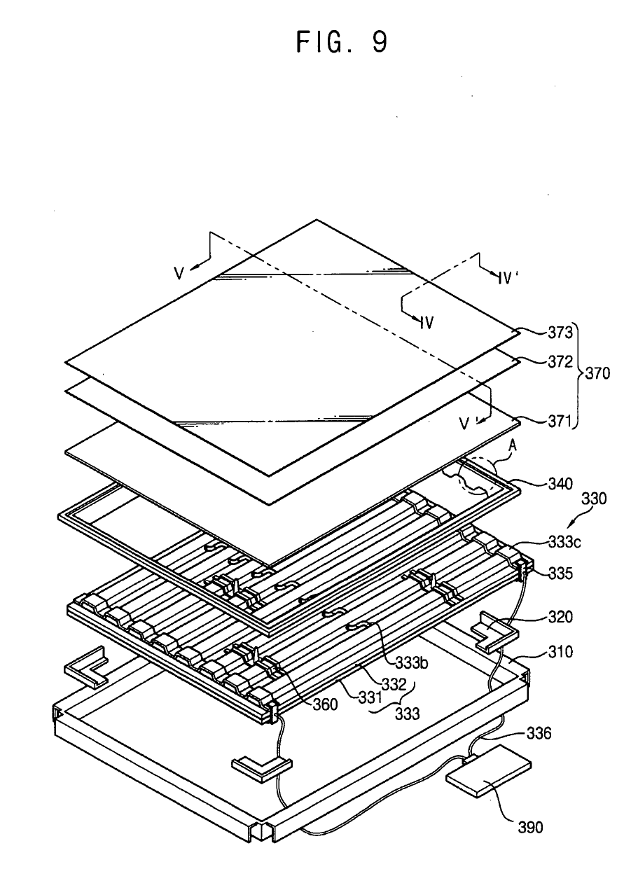

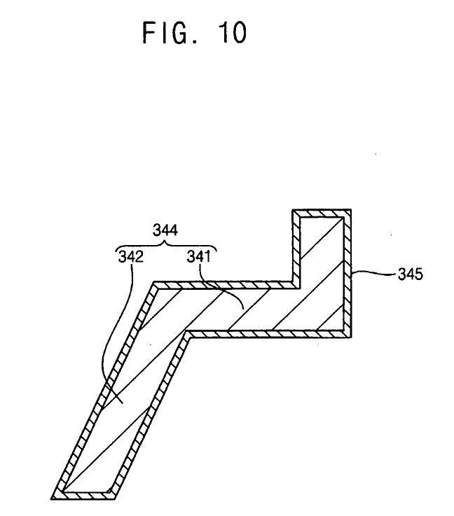

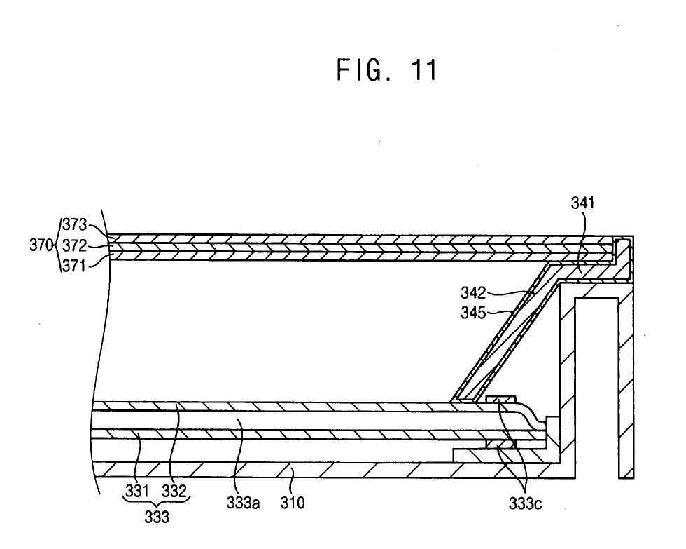

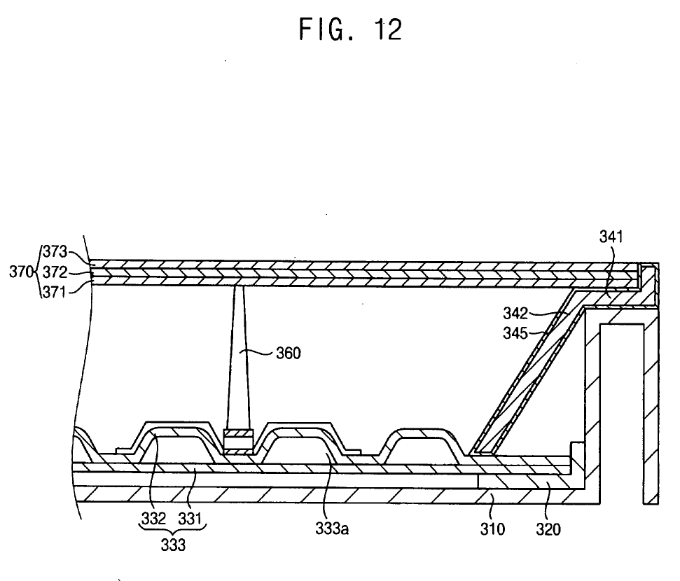

FIG. 9 is an exploded perspective view illustrating a backlight assembly according to yet another example embodiment of the present invention. FIG. 10 is an enlarged view illustrating the portion “A” in FIG. 9. FIG. 11 is a cross-sectional view taken along the line IV-IV′ in FIG. 9. FIG. 12 is a cross-sectional view taken along the line V-V′ in FIG. 9.

Referring to FIGS. 9 to 12, the backlight assembly includes a receiving container 310, a first supporting member 320, a lamp assembly 330, a mold frame 340, a second supporting member 360 and an optical member 370.

The receiving container 310 includes a bottom plate and a plurality of sidewalls that extend from the bottom plate. The bottom plate and the sidewalls define a receiving space. The first supporting member 320, the lamp assembly 330, the mold frame 340, the second supporting member 360 and the optical member 370 are disposed in the receiving space defined by the receiving container 310. A hole (not shown) is formed in the bottom plate to guide a lamp wire of the lamp assembly 330 towards the outside of the receiving container 310.

The first supporting member 320 is disposed between the receiving container 310 and the lamp assembly 330 and supports the lamp assembly 330. The first supporting member 320 is disposed at a corner of the lamp assembly 330. The first supporting member 320 supports the lamp assembly 330 so that the lamp assembly 330 is spaced apart from the bottom plate of the receiving container 310. Therefore, the first supporting member 320 electrically insulates the lamp assembly 330 from the receiving container 310. For example, the first supporting member 320 includes a dielectric material.

The first supporting member 320 includes an elastic material to absorb an impact applied thereto. In the embodiment shown, the first supporting member 320 includes four pieces disposed at four corners, respectively. Alternatively, the first supporting member 320 may include two U-shaped pieces disposed at two sides, respectively. As yet another alternative, the first supporting member 320 may be a single-piece frame.

The lamp assembly 330 includes a flat fluorescent lamp 333, an electrode clip 335 and a lamp wire 336.

The flat fluorescent lamp 333 includes a lamp body 333a having a plurality of discharge spaces, a connecting path 333b and an electrode 333c. The lamp body 333a includes a first substrate 331 and a second substrate 332. The second substrate 332 that is coupled to the first substrate 331 defines the plurality of discharge spaces. A reflective layer (not shown) is formed on an inner surface of the first substrate 331, which faces the second substrate 332, and a first fluorescent layer is formed on the reflective layer. A second fluorescent layer (not shown) is formed on the inner surface of the second substrate 332 facing the first substrate 331.

Discharge gas is injected into the discharge spaces defined by the lamp body 333a. The discharge gas may include mercury (Hg), argon (Ar), neon (Ne), xenon (Xe), krypton (Kr), or a combination thereof.

The connecting path 333b may be formed through the molding process of the second substrate 332. The discharge gas that is injected into one of the discharging spaces may flow to other discharge spaces through the connecting path 333b, so that pressure in the discharge spaces becomes substantially equal.

The electrode 333c is disposed on an outer surface of the lamp body 333a. The electrode 333c is disposed so that the electrode 333c overlaps each of the discharging spaces of the flat fluorescent lamp 333. In the embodiment shown, the electrode 333c extends in a direction perpendicular to the length of the discharging spaces. A driving voltage generated from a power supplier or an inverter 390 is applied to the electrode 333c.

The electrode clip 335 is electrically connected to the electrode 333c and provides the driving voltage with the electrode 333c.

The lamp wire 336 is electrically connected to the electrode clip 335 and transmits the driving voltage to the electrode clip 335. The lamp wire 336 extends through a hole (not shown) that is formed in a bottom surface of the receiving container 310 in order to be electrically connected to the inverter 390 disposed in a rear surface of the receiving container 310. “Front” and “rear” refer to the top and bottom in FIG. 9.

When the driving voltage is applied to the flat fluorescent lamp 333 from the electrode 333c, the discharge gas in the discharging spaces generates ultraviolet light. The ultraviolet light is converted into visible light by the first and second fluorescent layers. Alternatively, the reflective layer reflects the visible light generated by the first and second fluorescent layers to prevent light leakage of the visible light through the first substrate 331.

The mold frame 340 is disposed between the lamp assembly 330 and the optical member 370. The mold frame 340 reflects the light generated from the flat fluorescent lamp 333 and supports the optical member 370.

The mold frame 340 includes a body 344 and a silicone layer 345 that is coated on an outer surface of the body 344. The mold frame 340 is substantially the same as the mold frame described in FIGS. 1 and 2. The mold frame 340 is manufactured by the same manufacturing method described in FIGS. 3 to 4C.

The body 344 includes polycarbonate. The body 344 is formed through, for example, injection molding. The body 344 includes a first portion 341 and a second portion 342. The first portion 341 supports the optical member 370. The second portion 342 extends from the first portion 341 and secures the edge portions of the flat fluorescent lamp 333 and reflects the light generated from the flat fluorescent lamp 333.

The body 344 may include four pieces that are designed to be positioned at the four corners of the backlight assembly. Alternatively, the body 344 may include two pieces disposed at two end portions of the electrode 333c of the flat fluorescent lamp 333. Alternatively, the body 344 may be a single-piece frame shaped as shown in FIG. 9.

The silicone layer 345 is coated on the body 344 at a thickness of about 30 μm to about 40 μm in order to prevent the yellowing of the body 344 due to ultraviolet rays from the flat fluorescent lamp 333. The silicone layer may be made of a mixture of silicone resin and a reflecting material. The reflecting material may be a white material such as titanium oxide. Where titanium oxide is used, the titanium content is preferably between about 6% and about 7% by weight.

The second supporting member 360 is disposed between the flat fluorescent lamp 333 and the optical member 370, so that the optical member 370 is spaced apart from the flat fluorescent lamp 333 in a constant distance. The second supporting member 360 is disposed on a light exit surface of the flat fluorescent lamp 333. Therefore, the second supporting member 360 preferably includes an optically transparent material such as polyethylene terephthalate (PET), polymethyl methacrylate (PMMA), and polycarbonate(PC).

The optical member 370 includes a diffusing plate 371, a first prism sheet 372 and a second prism sheet 373. The diffusing plate 371 diffuses the light from the lamp 333 to enhance luminance uniformity.

The first and second prism sheets 372 and 373 are disposed on the diffusing plate 371. The first and second prism sheets 372 and 373 enhance a front-view luminance of the light generated from the diffusing plate 371. Additionally, a protecting sheet (not shown) may be disposed on the first and second prism sheets 372 and 373 so that the protecting sheet protects the first and second prism sheets 372, 373 from scratches or heat.

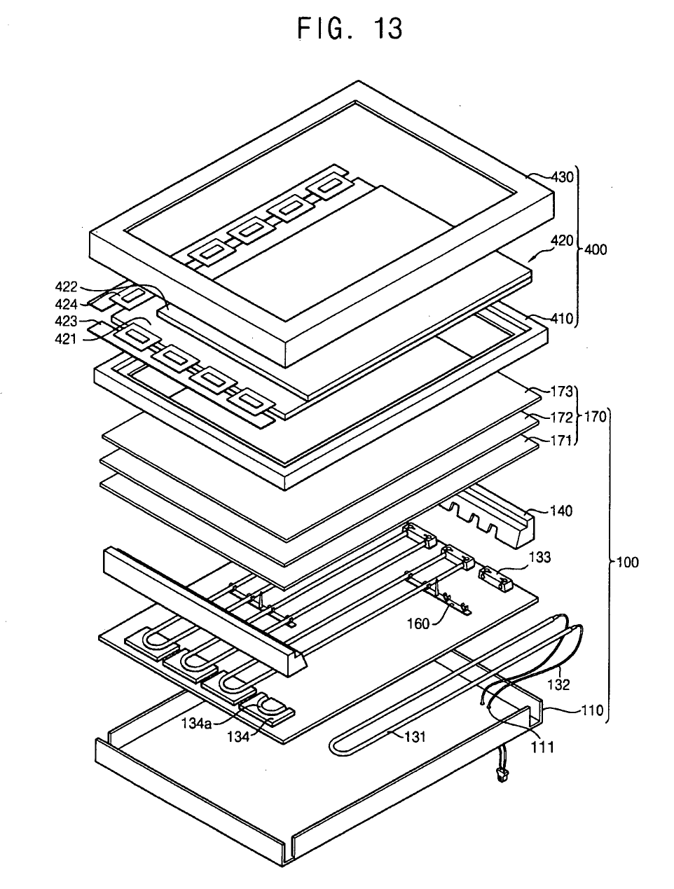

FIG. 13 is an exploded perspective view illustrating a display device according to yet another embodiment of the present invention.

Referring to FIG. 13, the display device includes a backlight assembly 100 and a display assembly 400. The backlight assembly 100 is substantially the same as in FIG. 5. Thus, the same reference numerals will be used to refer to the same or like parts as those described in FIG. 5, and any redundant explanation will be omitted.

The display assembly 400 includes a middle mold 410, a display panel 420 and a top chassis 430.

The middle mold 410 is disposed on the receiving container 110 that receives the optical member 170. The middle mold 410 secures the edge portions of the optical member 170 disposed on the first and second side molds 140 and 150. With the middle mold 410, the optical member 170 is fastened to the receiving container 110.

The display panel 420 includes a first substrate 421, a second substrate 422, a liquid crystal layer (not shown), a printed circuit board 423 and a flexible printed circuit (FPC) 424. The first substrate 421 includes a plurality of pixel electrodes, a plurality of thin film transistors (TFTs) and a plurality of wirings. The pixel electrodes are arranged in a matrix configuration.

The pixel electrode may be made of an optically transparent and electrically conductive material such as indium tin oxide (ITO), indium zinc oxide (IZO), or amorphous indium tin oxide film (a-ITO), among others.

The second substrate 422 is positioned in a plane that is substantially parallel to the plane of the first substrate 421. The second substrate 422 includes a common electrode facing the pixel electrodes and a plurality of color filters corresponding to the pixel electrodes, respectively. The color filters include a red filter, a green filter and a blue filter.

The liquid crystal display layer (not shown) is disposed between the first and second substrates 421 and 422. When electric field is applied to the liquid crystal layer (not shown), the arrangement of liquid crystal molecules in the liquid crystal layer is altered, which changes the optical transmissivity of the liquid crystal layer. Hence, the desired image is displayed.

The printed circuit board 423 includes a driving circuit unit (not shown) processing an image signal. The driving circuit unit processes an image signal and a control signal provided from an external device and outputs a driving control signal and an image signal to drive the first and second substrates 421 and 422.

The FPC 424 that electrically connects the printed circuit board 423 to the first substrate 421 transfers a driving signal from the printed circuit board 423 to the first substrate 421. The driving signal includes a data signal and a gate signal for driving the thin film transistor (TFT) formed on the first substrate 421 and is based on the driving control signal and the image signal provided from the printed circuit board 423.

The top chassis 430 surrounds peripheral portions of the display panel 420. The top chassis 430 is combined with the receiving container 110 to secure the display panel 420. The top chassis 430 protects the display panel 420 from being damaged. The top chassis 430 prevents the display panel 420 from separating from the receiving container 110.

Alternatively, the display device may employ one of the backlight assemblies described above.

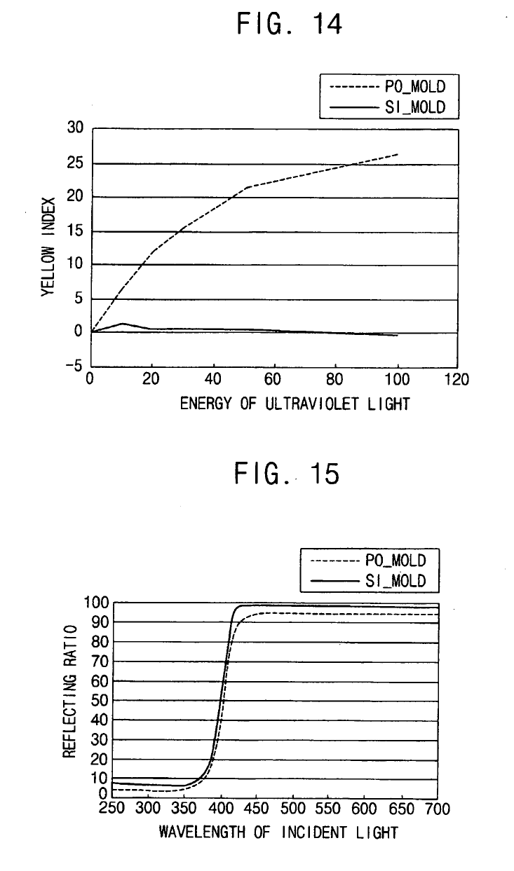

FIG. 14 is a graph showing a relationship between ultraviolet light and yellow index. FIG. 15 is a graph showing a relationship between the wavelength of incident light and a reflecting ratio.

Referring to FIG. 14, for a conventional mold frame PO_MOLD including a polycarbonate (PC) body and no silicone layer, when the energy of ultraviolet light increases, yellow index increases.

However, for the mold frame SI_MOLD including a polycarbonate body and a silicone layer coated on the polycarbonate body, yellow index remains about zero even when an energy of ultraviolet light increases. This result indicates that the mold frame having a silicone layer is not affected by the energy level of ultraviolet light. Although the energy level of ultraviolet light is increased, the yellowing does not increase.

Referring to FIG. 15, the conventional mold frame PO_MOLD including a polycarbonate (PC) body and no silicone layer has a reflecting ratio (Y—axis) of about 92% to about 93%. In comparison, the mold frame SI_MOLD including a polycarbonate body and a silicon layer coated on the polycarbonate body has a reflecting ratio (Y—axis) of about 98%. These numbers indicate that the reflecting ratio of the mold frame SI_MOLD according to the present invention is higher by about 5% compared to that of the conventional mold frame.

In the mold frame according to the embodiment of present invention, discoloring or yellowing is not caused, and the reflection ratio is increased. Therefore, the overall display quality of a display device is enhanced.

In detail, a silicone layer is coated on surfaces of the mold frame according to the present invention, and the silicone layer prevents yellowing caused by ultraviolet radiation from the fluorescent lamp in the mold frame.

Furthermore, the silicone layer is coated on a surface of the lamp supporting member supporting the lamp, and thus effectively prevents yellowing caused by ultraviolet light in the lamp supporting member.

Since yellowing does not occur on a mold frame and a lamp supporting member on which a silicone layer is coated, the appearance of the mold frame, a backlight assembly using the lamp supporting member, and a display device may be improved.

Although the embodiments of the present invention have been described, it is understood that the present invention should not be limited to these exemplary embodiments. Various changes and modifications can be made by one ordinary skilled in the art within the spirit and scope of the present invention as hereinafter claimed.

What is claimed is:

1. A mold frame covering an end portion of a lamp and supporting an optical member disposed over the lamp, the mold frame comprising:
a first portion supporting the optical member;
a second portion extending from the first portion to reflect light generated from the lamp; and
a silicone layer coated on the second portion.

2. The mold frame of claim 1, further comprising a silicone layer coated on the first portion.

3. The mold frame of claim 1, wherein the silicone layer has a thickness of between about 30 μm and about 40 μm.

4. The mold frame of claim 1, wherein the silicone layer comprises a reflecting material.

5. The mold frame of claim 4, wherein the reflecting material comprises titanium oxide.

6. The mold frame of claim 4, wherein a content of the reflecting material is between about 6% and about 7% by weight.

7. A method of manufacturing a mold frame, the method comprising:
forming a body having a first portion that supports an optical member and a second portion that extends from the first portion, the second portion reflecting light generated from a lamp;
forming an adhesive layer on a surface of the body; and
forming a silicone layer on the adhesive layer.

8. The method of claim 7, wherein the body comprises polycarbonate.

9. The method of claim 7, wherein the silicone layer has a thickness of between about 30 μm and about 40 μm.

10. The method of claim 7, wherein the silicone layer comprises a reflecting material.

11. The method of claim 10, wherein the reflecting material comprises titanium oxide.

12. The method of claim 10, wherein a content of the reflecting material is between about 6% and about 7% by weight.

13. The method of claim 7, further comprising dehumidifying the adhesive layer.

14. The method of claim 7, further comprising dehumidifying the silicone layer.

15. A backlight assembly comprising:
a lamp generating light;
an optical member disposed on the lamp, the optical member enhancing characteristics of the light from the lamp;
a receiving container receiving the lamp and the optical member; and
a mold frame disposed on a bottom plate of the receiving container to hold the lamp and support the optical member, the mold frame having a silicone layer coated thereon.

16. The backlight assembly of claim 15, further comprising a lamp supporting member that supports the lamp and allows the optical member to be space apart from the lamp, wherein the lamp supporting member is secured to the receiving container.

17. The backlight assembly of claim 16, wherein the lamp supporting member comprises a silicone layer.

18. The backlight assembly of claim 15, wherein the lamp is an external electrode fluorescent lamp.

19. The backlight assembly of claim 15, wherein the lamp is an inner electrode fluorescent lamp.

20. The backlight assembly of claim 15, wherein the lamp is a flat fluorescent lamp.

21. A display device comprising:
a display panel that displays an image; and
a backlight assembly that provides the display panel with light, the backlight assembly including;
a lamp generating light;
an optical member enhancing characteristics of the light generated from the lamp; and
a mold frame having a silicone layer coated thereon, the silicone layer including a reflecting material, and the mold frame covering an end portion of the lamp and supporting the optical member.

22. The display device of claim 21, further comprising a lamp supporting member that supports the lamp and allows the optical member to be spaced apart from the lamp, the lamp supporting member being secured to the receiving container.
